(19) United States
(12) Patent Application Publication
(10) Pub. No.: US 2008/0147985 A1
(43) Pub. Date: Jun. 19, 2008

(54) Method and System for Purging Data from a Controller Cache

(75) Inventors: Tara L. Astigarraga, Tucson, AZ (US); Michael E. Browne, Staatsburg, NY (US); Joseph Demczar, Salt Point, NY (US); Eric C. Wieder, New Paltz, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 11/610,198

(22) Filed: Dec. 13, 2006

(51) Int. Cl. G06F 12/08

(52) U.S. Cl. 711/135; 711/E12.022

(57) ABSTRACT

Disclosed are a method, system and computer program for purging data in a data storage system comprising a plurality of hosts one or more data storage devices and a controller, the controller including a cache. In accordance with the present invention, a communication interface is implemented between operating systems (OS) and the storage controller, of a multi-host data storage system, to signal the storage controller when the host is being shutdown. When the storage controller gets the signal, the controller purges the controller cache of any pages belonging to that host and puts those pages back into the free pool.

### BACKGROUND OF THE INVENTION

1. Field of the Invention

This invention generally relates to computer systems, and more specifically, to procedures for purging data in computer systems. Even more specifically, the preferred embodiment of the invention relates to a procedure, for use with a multi-host, high capacity data storage system, for purging data from the controller cache of the system.

2. Background Art

Data storage systems such as storage servers as commonly used by corporations and other organizations have high-capacity disk arrays to store large amounts of data from external host systems. A data storage system may also backup data from another data storage system, such as at a remote site. The IBM Enterprise Storage Server (ESS) is an example of such a data storage system. Such systems can access arrays of disks or other storage media to Store and retrieve data. Moreover, redundant capabilities may be provided as a further safeguard against data loss. For example, the IBM ESS is a dual cluster storage server that includes two separate server dusters that can access the same storage disks.

As a typical example, a multi-host, high capacity data storage system may comprise a processor complex, a group of host adapters, and one or more storage devices. The host adapters are used to connect the processor complex to the hosts; and the processor complex receives data from those hosts, determines where the data are to be stored, and then sends the data to the appropriate storage location. The processor complex may perform other functions such as copying or mirroring data, monitoring the stored data, and monitoring the performance of the storage devices.

The processor complex itself commonly includes a processor controller, a non-volatile storage, and a cache. The processor controller performs the processing functions of the complex, and the non-volatile storage may be used to store data that are needed as potential backup in case of a power outage. The cache may be used to buffer data as they are received from the hosts or transferred within the storage system, and the cache may also store data frequently accessed by one or more of the hosts.

Enterprise storage subsystems often have many hosts attached, which can be in various states of running, booting, powered off, etc. When hosts boot and begin running applications, some number of often accessed or pinned pages of data will reside in the storage controller cache. If a host is powered off, the storage controller has no reason to cache the pinned data for that host, and that pinned data could be purged to free up space for data frequently accessed by other hosts.

### SUMMARY OF THE INVENTION

An object of this invention is to provide a procedure for purging data from a controller cache of a data storage system.

Another object of the invention is to purge selected data from die cache of a controller, of a multi-host data storage system, when a host of the system, shuts down.

A further object of the present invention is to signal the controller of a data storage system when a host of the system is being shut down, and in response to that signal, to purge the controller cache of any data pages belonging to that host.

These and other objectives are attained, in accordance with the present invention, by implementing a communication interface between operating systems (OS) and the storage controller, of a multi-host data storage system, to signal the storage controller when the host is being shutdown. When the storage controller gets the signal, the controller purges the controller cache of any pages belonging to that host and puts those pages back into the free pool.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a data storage system in which the present invention may be implemented; and

FIG. 2 is a flow chart showing a preferred embodiment of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

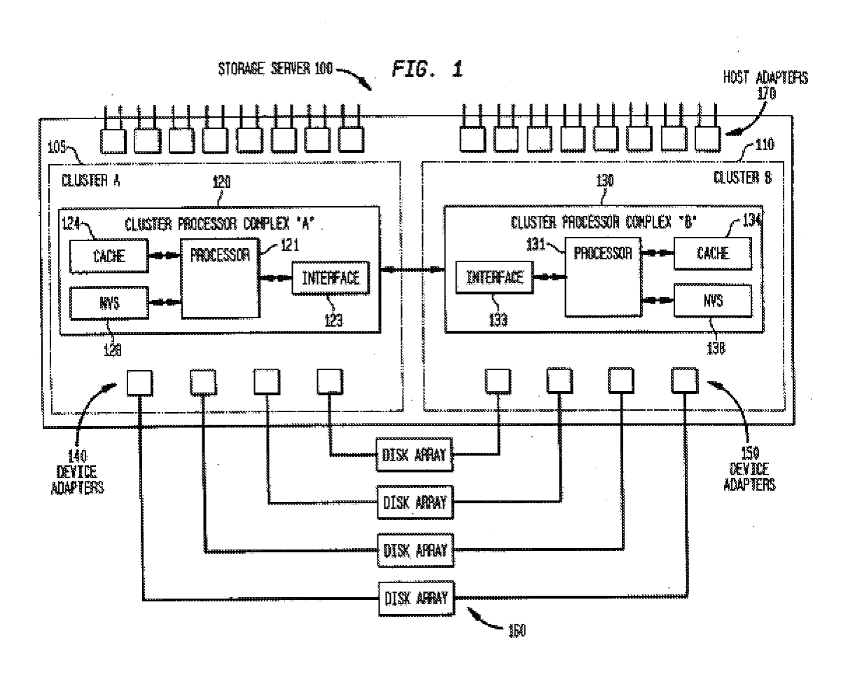

FIG. 1 illustrates a data storage system according to the invention. A data storage system or storage server 100, such as the IBM Enterprise Storage Server (ESS), for instance, is a high-capacity storage device that can back up data from a variety of different devices. For example, a large corporation or other enterprise may have a network of servers that each store data for a number of workstations used by individual employees. Periodically, the data on the host servers is hacked up to the high-capacity data storage system 100 to avoid data loss if the host servers malfunction. The data storage system 100 can also provide data sharing between host servers since it is accessible to each host server. The data storage system 100 can have redundant resources to provide an additional safeguard against data loss. However, an aspect of the invention is also suitable for use with only one server or server cluster. As a further measure, the data of the data storage system 100 may be mirrored to another storage server, typically at a remote site. A user interface may be provided to allow a user to access information regarding the status of the data storage system 100.

The example data storage system 100 includes two clusters for redundancy. Each cluster 105, 110, e.g., “A” and “B”, respectively, works independently, with its own operating system, and may include cluster processor complexes 120, 130 with cluster cache 124, 134, nonvolatile storage (NVS) 128, 138, and device adapters 140, 150. The device adapters (DA) 140, 150 are used to connect disks in the disk arrays 160 to the cluster processor complexes 120, 130. Each cluster 105, 110 contains four device adapters 140, 150. Each adapter is part of a pair, one on each cluster. A pair supports two independent paths to all of the disk drives served by the pair. Each disk array 160 is configured to be accessed by only one of the clusters. However, if a cluster failure occurs, the surviving cluster automatically takes over all of the disks. The disk arrays or ranks 160 can be configured as RAID (redundant array of independent disks) or non-RAID arrays. Alternatively, another high-capacity storage medium may be used.

Processors 121 and 131 execute software, including, e.g., firmware and/or micro code, to achieve the functionality described herein. The software may be stored in NVSs 128 and 138, respectively, for example, which are considered to be program storage devices. Interfaces 123 and 133, such as network interface cards, allow the clusters 105 and 110 to communicate with one another.

Host adapters (HAs) 170 are external interfaces that may support two ports, e.g., either small computer systems interface (SCSI) or IBM's enterprise systems connection (ESCON), which is an Enterprise Systems Architecture/390 and zSeries computer peripheral interface. Each HA connects to both cluster processor complexes 120, 130 so that either cluster can handle I/Os from any host adapter. The data storage system 100 contains four host-adaptor bays, each of which is connected to both clusters 105,110 for redundancy.

The data storage 160 may be arranged into various logical data storage units. For example, the data storage devices may be arranged as an array with logical data storage partially occupying all or some of the data storage devices. In the example of the IBM ESS, the data storage devices 160 comprise magnetic disk drives or arrays of magnetic disk drives. Alternatively, the data storage devices 160 may comprise optical drives or arrays, or devices that have direct or random access characteristics.

As mentioned above, enterprise storage subsystems often have many hosts attached, which can be in various states of running, booting, powered off, etc. When hosts boot and begin running applications, some number of often accessed or pinned pages of data will reside in the storage controller cache. If a host is powered off, the storage controller has no reason to cache the pinned data for that host.

In accordance with the present invention, a communication interface is implemented between operating systems (OS) and the storage controller, of a multi-host data storage system, to signal the storage controller when the host is being shutdown. When the storage controller gets the signal, the controller purges the controller cache of any pages belonging to that host and puts those pages back into the free pool.

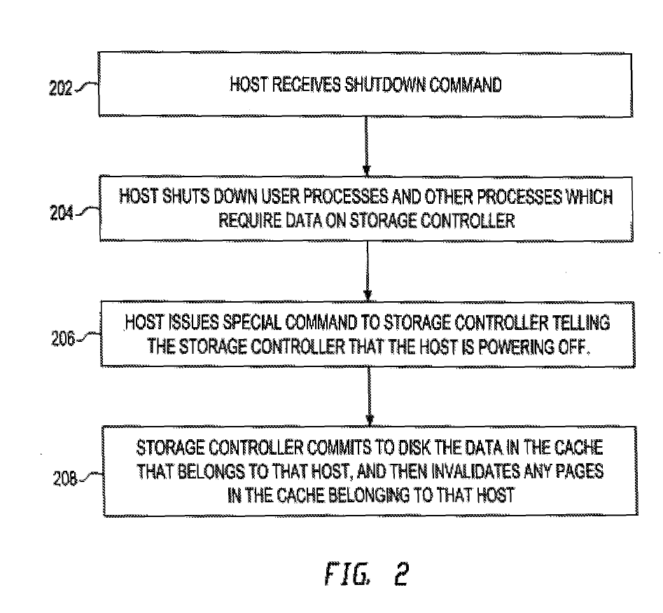

With particular reference to FIG. 2, on a normal, or graceful, shutdown of a host attached to a storage controller 120, 130, the following sequence is preferably executed: At step 202, the host receives a “shutdown” command from the operator at, for example, a command line or PHYP through a HMC interface. At step 204, the host shuts down the user processes and other processes which require data on the storage controller; and at step 206, the host issues a special command to the storage controller over, for example, SAN telling the storage controller that the host is powering off. At step 210, the storage controller commits to disk the data in the cache mat belongs to that host, and then invalidates any pages in cache 124, 134 belonging to the host that shut down.

As will be readily apparent to those skilled in the art, the present invention can be realized in hardware, software, or a combination of hardware and software. Any land of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method for purging data in a data storage system comprising a plurality of host computers, one or more data storage devices and a storage controller, said storage controller including a controller cache, the method comprising the steps of:
when one of the host computers is being shut down, receiving a specified command at the storage controller; and
the storage controller, after receiving said specified command, purging from the storage controller cache selected data associated with said one of the host computers.

2. The method according to claim 1, comprising the further step of said one of the host computes sending said specified command to said Storage controller.

3. The method according to claim 2, comprising the further step of, when said purging is complete, said storage controller sending a response to said one of the host computers indicating the purging is complete.

4. A method according to claim 3, wherein the purging step includes the step of the storage controller, in response to receiving said specified command, purging from the controller cache only data belonging to said one of the host computers.

5. A method according to claim 1, comprising the further step of the storage controller, after receiving said specified command and prior to purging said selected data, copying said selected data to said one or more of the data storage devices.

6. A method according to claim 1, wherein the purging step includes the step of invalidating in the controller cache any pages belonging to said first host computer.

7. A method according to claim 6, wherein the purging step includes the further step of putting said any pages in a free pool.

8. A system for purging data in a data storage system comprising a plurality of host computers, one or more data storage devices and a storage controller, said storage controller including a controller cache, the system comprising:
first computer readable program code on the storage controller for receiving a specified command when one of the hosts is being shut down;
the first computer readable program code, after receiving said specified command, purging from the storage controller cache selected data associated with said one of the host computers.

9. The system according to claim 8, further comprising second computer readable program code for sending said specified command to said storage controller in response to a pending host computer shut down event.

10. The system according to claim 9, wherein when said purging is complete, said first computer readable program code sends a response to said one of die host computers indicating the purging is complete.

11. A system according to claim 10, wherein the first computer readable program code configures the storage controller to function, in response to receiving said specified command, to purge from the controller cache only data belonging to said one of the host computers.

12. A system according to claim S, wherein the first computer readable program code configures the storage controller to function, after receiving said specified command and prior to purging said selected data, to copy said selected data to said one or more of the data storage devices.

13. A system according to claim 8, wherein the first computer readable program code configures the storage controller to invalidate in the controller cache any pages belonging to said first host computer.

14. A system according to claim 8, wherein each of said plurality of hosts includes said second computer readable program code.

15. A program storage device readable by machine, tangibly embodying a program of instructions executable by the machine to perform method steps for purging data in a data storage system comprising a plurality of host computers, one or more data storage devices and a storage controller, said storage controller including a controller cache, the method steps comprising;
when one of the host computers is being shut down, receiving a specified command at the storage controller; and
the storage controller, after receiving said specified command, purging from the storage controller cache selected data associated with said one of the host computers.

16. The program storage device according to claim 15, wherein said method steps comprise the further step of said one of the host computers sending said specified command to said storage controller.

17. The program storage device according to claim 16, wherein said method steps comprise the further step of when said purging is complete, said storage controller sending a response to said one of the host computers indicating the purging is complete.

18. A program storage device according to claim 17, wherein the purging step includes the step of the storage controller, in response to receiving said specified command, purging from the controller cache only data belonging to said first host computer.

19. A program storage device according to claim 1S, wherein said method steps comprise the further step of the storage controller, after receiving said specified command and prior to purging said selected data, copying said selected data to said one or more of the data storage devices.

20. A program storage device according to claim 15, wherein the purging step includes the step of invalidating in the cache any pages belonging to said first host computer.
